(19) United States
(12) Patent Application Publication
(10) Pub. No.: US 2022/0355365 A1
(43) Pub. Date: Nov. 10, 2022

(54) SIZED MOLDS OBTAINABLE FROM A MOLDING MATERIAL MIXTURE CONTAINING AN INORGANIC BONDING AGENT AND PHOSPHATIC COMPOUNDS AND OXIDIC BORON COMPOUNDS AND METHOD FOR PRODUCTION AND USE THEREOF

(71) Applicant: ASK Chemicals GmbH, Hilden (DE)

(72) Inventors: Felix MÜCK, Schweinfurt (DE); Tamara Jacqueline HOLTHAUSEN, Erkelenz (DE); Ronja MÜLLER, Wülfrath (DE)

(21) Appl. No.: 17/619,778

(22) PCT Filed: Jun. 18, 2020
(86) PCT No.: PCT/DE2020/100518

§ 371 Date: Dec. 16, 2021

(30) Foreign Application Priority Data
Jun. 19, 2019 (DE) 10 2019 116 702.7

(51) Int. Cl. B22C 1/18; B22C 3/00; B22C 9/12; B22C 9/10; C04B 35/14; C04B 35/64; C04B 41/50; C04B 41/45

(52) U.S. Cl. CPC B22C 1/185; B22C 3/00; B22C 9/12; B22C 9/10; C04B 35/14; C04B 35/64; C04B 41/5037; C04B 41/4539; C04B 2235/3418; C04B 2235/3427; C04B 2235/447; C04B 2235/3409; C04B 2235/5436; C04B 2235/5445; C04B 2235/5409; C04B 2235/656; C04B 2235/9676

(57) ABSTRACT

Sized molds for metal casting are obtained from molding material mixtures on the basis of inorganic bonding agents containing at least one phosphatic compound and at least one oxidic boron compound, especially sized, water glass-bound forms and cores, having at least one refractory base molding material, water glass as inorganic bonding agent and amorphous particulate silicon dioxide and one or more powdery oxidic boron compounds and one or more phosphatic compounds. The invention furthermore relates to a method for producing sized foundry mold bodies and use thereof, in particular for producing cast parts from iron alloys. The sizing is a water-based sizing.

The invention relates to coated casting moulds for the cast metal obtainable from moulding material mixtures based on inorganic binders, containing at least one phosphate-containing compound and at least one oxidic boron compound, that is to say coated, water-glass-bonded moulds and cores comprising at least one refractory mould base material, water glass as inorganic binder and amorphous particulate silica, as well as one or more oxidic boron compounds and one or more phosphate-containing compounds, in particular for the production of ferrous alloy castings. Furthermore, the invention relates to a method for the production of coated foundry mouldings and their use, in particular for the production of ferrous alloy castings. The coating is a water-based coating.

### TECHNICAL ENVIRONMENT

Casting moulds are essentially composed of cores and moulds which represent the negative mould of the casting to be produced. In the following, the term casting mould (including its plural form) is used as a synonym for cores, moulds (individually) as well as for cores and moulds (together). Therein, the moulds and cores are usually based on a refractory material, for example silica sand, and a suitable binder that gives the casting mould sufficient mechanical strength after having been removed from the moulding tool. For the production of casting moulds, a refractory mould base material is used which is coated with a suitable binder. The refractory mould base material is preferably available in free-flowing form so that it can be filled into a suitable hollow mould and compacted there. The binder generates a firm cohesion between the particles of the mould base material, giving the casting mould the necessary mechanical stability.

Casting moulds have to fulfil various requirements. During the casting process itself, they must first have sufficient strength and temperature resistance to accommodate the molten metal in the cavity formed by one or more casting moulds. After the solidification process begins, the mechanical stability of the casting is ensured by a solidified metal layer that forms along the walls of the casting mould.

The material of the casting mould must now decompose under the influence of the heat emitted by the metal in such a way that it loses its mechanical strength, i.e. the cohesion of the individual particles of the refractory material is removed. Ideally, the casting mould re-disintegrates into a fine sand that can be easily removed from the casting.

Since casting moulds are subjected to very high thermal and mechanical stresses during the casting process, defects can occur at the contact surface between the liquid metal and the casting mould, for example by the casting mould cracking or by liquid metal penetrating into the structure of the casting mould.

Where necessary, especially in steel and iron casting, the surfaces of foundry mouldings, in particular of moulds and cores, are coated with a coating layer, especially those surfaces that come into contact with cast metal. Coatings form a boundary or barrier layer between the mould/core and the metal, e.g. for the targeted suppression of defect mechanisms at these points or for the utilisation of metallurgical effects. In general, coatings in foundry technology are above all intended to fulfil the following functions:
improving the smoothness of the casting surface;
separating the liquid metal from the mould and/or core as completely as possible;
avoiding chemical reactions between components of the mould/core and the melt, thereby facilitating the separation between mould/core and casting; and/or
avoiding surface defects on the casting, such as gas bubbles, penetrations, veinings and/or scabs.

If the defects described above occur, extensive reworking of the surface of the casting is necessary in order to achieve the desired surface properties. This requires additional work steps and thus a drop in productivity and an increase in costs. If the defects occur on surfaces of the casting that are poorly accessible or not accessible at all, this can also lead to a loss of the casting.

Furthermore, the coating can influence the casting metallurgically, for example by selectively transferring additives into the casting via the coating at the surface of the casting, said additives improving the surface properties of the casting.

Furthermore, the coatings form a layer that chemically isolates the casting mould from the liquid metal. This reduces the adhesion between the casting and the casting mould, so that the casting can be easily removed from the casting mould. However, the coating can also be used to specifically control the heat transfer between the liquid metal and the casting mould, for example, to cause the formation of a specific metal structure through the cooling rate.

A coating usually consists of an inorganic refractory material and a binder, wherein the coatings are dissolved or suspended in a suitable carrier liquid, for example water or alcohol. If possible, it is preferred to do without alcohol-based coatings and use aqueous systems instead, as the organic solvents cause emissions in the course of the drying process.

In recent times in particular, there has been an increasing demand for emissions in the form of CO₂ or hydrocarbons to be kept at zero level if possible during the production of the casting moulds and during casting and cooling, in order to protect the environment and limit the odour nuisance to the surroundings caused by hydrocarbons, mainly aromatic hydrocarbons. To meet these requirements, inorganic binder systems have been developed or refined in recent years, the use of which means that emissions of CO₂ and hydrocarbons can be avoided or at least significantly minimised during the production of metal moulds. However, the use of inorganic binder systems is often associated with other disadvantages, which are described in detail in the following.

Compared to organic binders, inorganic binders are disadvantageous in that the casting moulds made from them have relatively low strengths. This is particularly evident immediately after the casting mould has been removed from the tool. At this stage, however, good strengths are particularly important for the production of complicated and/or thin-walled moulded parts and their safe handling.

Moulds and cores made with inorganic binders such as water glass also have a comparatively low resistance to humidity or to water or aqueous moisture. This means that the application of a water-based or water-containing coating and the storage of such foundry moulds or cores over a longer period of time, as is usual with organic moulding material binders, is often not possible.

As compared with organic binder systems, inorganic binder systems are disadvantageous in that the coring behaviour, i.e. the ability of the casting mould to quickly decay (under mechanical stress) into a light pourable form after metal casting, is often worse in the case of purely inorganically produced casting moulds (e.g. those using water glasses as a binder) than in the case of casting moulds produced with an organic binder. This is especially true for cast iron applications.

This latter property, i.e. a poorer coring behaviour, is particularly disadvantageous when thin-walled, filigree or complex casting moulds are used, which are in principle difficult to remove after casting. As an example, so-called water jacket cores can be attached here, which are necessary in the production of certain areas of an internal combustion engine.

EP 1802409 B1 discloses that higher instant strengths and higher resistance to humidity can be realised by using a refractory mould base material, a binder based on water glass and additives of particulate amorphous silicon dioxide.

DE 102013106276 A1 discloses that a higher resistance to humidity as well as to water-based coatings can be realised by using a lithium-containing moulding material mixture based on an inorganic binder, in particular in combination with amorphous silica. This ensures safe handling even of complicated casting moulds.

EP 2097192 B1 discloses that by using one or more phosphorus-containing compounds in combination with amorphous silica, a significantly higher heat strength can be achieved. In addition, test specimens made from phosphate-containing moulding material mixtures show significantly improved thermal stability with a time delay or reduction in “hot deformation”.

It is further disclosed that despite the high strengths, casting moulds produced from the moulding material mixtures according to the invention show very good disintegration, especially in the case of aluminium casting.

WO 2015058737 A2 discloses that higher bending strengths can be realised after storage in humidity by using one or more boron oxide compounds. This additive ensures improved handling even of complicated casting moulds. It is further disclosed that despite the high strengths of the casting moulds made from the moulding material mixtures, they show very good disintegration, especially in the case of aluminium casting.

Problems of the State of the Art and Object Definition

In order to be able to meet the increasing requirements in the area of environmental protection and emission control, inorganic moulding material binders, especially water-containing moulding material binders, should in the future also gain importance in the production of moulds and cores in the area of steel and iron casting. In order to achieve the desired or necessary castings, it is usually necessary or advantageous to coat inorganically bonded moulds and cores with a coating, as mentioned above. In terms of environmental protection and emission control, it is therefore also desirable when selecting the coating to avoid the use of organic carrier fluids as far as possible or to preferably use water-based coatings, i.e. coatings with water as the sole carrier fluid or as at least the predominant content (in terms of weight) of carrier fluid.

However, as mentioned above, foundry mouldings, in particular moulds and cores, made with inorganic moulding material binders, in particular with water-containing moulding material binders, have a low stability to the action of water or aqueous moisture. The water contained in water-based coating compositions can therefore damage the inorganically bonded moulds and cores treated (coated) with them. In particular, this can adversely reduce the strength of the moulds and cores thus coated. This problem is well known in foundry technology and can so far only be solved to an inadequate degree if current means including, for example, particularly intensive hardening of the moulds and cores, complex methods for drying the applied coating or the adjustment of the moulding material mixture or of the coating composition (DE 102017107655 A1/DE 102017107657 A1/DE 102017107658 A1) are used.

The inorganic binder systems known so far for foundry purposes, especially in the area of iron and steel casting, still show room for improvement. Above all, it is desirable to develop an inorganic binder system for iron and steel casting which:
achieves a corresponding strength level which is necessary in the automated production process (especially strengths in the process of drying the coating and strengths after storage);
has a particularly high moisture resistance and thus enables compatibility with water-based coatings, so that even particularly thin-walled or filigree or complex inorganic casting moulds can be reliably coated without mould and/or core breakage;
enables or at least improves the application of a water-based coating to moulds and/or cores (i.e. in particular to those moulds and/or cores which, e.g. due to incomplete cooling after thermal setting, still have temperatures of more than 50° C., preferably temperatures in the range of 50 to 100° C.);
enables a very good surface finish of the manufactured casting, so that no or at least only minor reworking is necessary.

The invention was therefore based on the object of providing an inorganic moulding material mixture for the production of casting moulds for metal processing, in particular of iron and iron alloys, which particularly effectively improves the stability with respect to environmentally friendly water-based coatings and at the same time ensures a high strength level in the coating-drying process, which is necessary in the automated process for the production of particularly thin-walled or filigree or complex coated casting moulds.

Furthermore, the casting mould should have a high storage stability and very good disintegration properties.

### SUMMARY OF THE INVENTION

The above objects are achieved by moulds and/or cores and the use of or the method having the features of the independent claims. Advantageous refinements of the moulding material mixture according to the invention are the subject of the dependent claims or are described below.

Surprisingly, it was found that the presence of at least one oxidic boron compound (i) and at least one phosphate-containing compound (ii) in inorganic moulding material mixtures containing a binder based on water glass and amorphous silica makes casting moulds, i.e. moulds and/or cores, accessible which, when coated, achieve the objects described above.

A decisive unique feature is that the inorganic moulding material mixtures used in accordance with the invention also allow complex component geometries to be produced in iron casting with reduced or zero emissions.

The casting moulds according to the invention, i.e. moulds or cores, for metal processing are obtainable from moulding material mixtures comprising at least:
a refractory mould base material;
a binder comprising at least water glass;
particulate amorphous silicon dioxide;
an oxidic boron compound, in particular in powder form; and
a phosphate-containing compound, in particular in powder form or dissolved, e.g. dissolved in water;
   and will
after moulding and setting to obtain a coated casting mould, be provided with a coating, at least partially and in particular completely, at least on those surfaces of the casting mould which come into contact with the cast metal.

Parts of the binder are the water glass, the particulate amorphous silicon dioxide, the oxidic boron compound and the phosphate-containing compound.

Materials that are commonly used and known for the production of casting moulds may be used as refractory moulding base material.

Suitable are, for example, silica sand, zircon sand or chrome ore sand, olivine, vermiculite, bauxite, fireclay, as well as artificial mould base materials, in particular those with more than 50% by weight of silica sand relative to the refractory mould base material. Therein, it is not necessary to use only new sand. In terms of resource conservation and to avoid landfilling costs, it is even advantageous to use the highest possible content of regenerated used sand such as it is obtainable from recycling used moulds.

A refractory mould base material is understood to be substances that have a high melting point (melting temperature). Preferably, the melting point of the refractory mould base material is greater than 600° C., preferably greater than 900° C., more preferably greater than 1200° C. and most preferably greater than 1500° C.

The refractory mould base material preferably constitutes more than 80% by weight, more preferably more than 90% by weight, most preferably more than 95% by weight, of the moulding material mixture.

A suitable sand is described, for example, in WO 2008/101668 A1 (=US 2010/173767 A1). Regenerates obtained by washing and subsequent drying of crushed moulds are likewise suitable. As a rule, the regenerates may constitute at least about 70% by weight, preferably at least about 80% by weight and most preferably greater than 90% by weight of the refractory mould base material.

The average diameter of the moulding base materials is usually between 120 μm and 600 μm and preferably between 150 μm and 500 μm. The particle size can be determined e.g. by sieving according to DIN ISO 3310. Particle geometries having a ratio of the greatest linear expansion to the smallest linear expansion (at right angles to each other and in each case for all spatial directions) of 1:1 to 1:5 or 1:1 to 1:3 are particularly preferred, i.e. those that are not fibrous, for example.

The refractory mould base material has a free-flowing state, in particular in order to be able to process the moulding material mixture according to the invention in conventional core shooters.

The water glasses contain dissolved alkali silicates and can be made by dissolving glassy lithium, sodium and/or potassium silicates in water. The water glass preferably has a molar modulus SiO₂/M₂O (cumulative at different M values, i.e. in the sum) in the range of 1.6 to 4.0, in particular 2.0 to less than 3.5, where M stands for lithium, sodium and/or potassium. The binders may also be based on water glasses containing more than one of the alkali ions mentioned, such as the lithium-modified water glasses known from DE 2652421 A1 (=GB 1532847 A). Furthermore, the water glasses may also contain multivalent ions such as the aluminium-modified water glasses described in EP 2305603 A1 (=WO 2011/042132 A1). Water glass containing a content of lithium ions, especially amorphous lithium silicates, lithium oxides and lithium hydroxides, or having a ratio [Li₂O]:[M₂O] or [Li₂O_{active}]:[M₂O] as described in DE 102013106276 A1, is particularly preferred.

The water glasses have a solids content in the range of from 25 to 65% by weight, preferably from 33 to 55% by weight, most preferably from 30 to 50% by weight. The solids content refers to the amount of SiO₂ and M₂O contained in the water glass.

Depending on the application and the desired strength level, the water-glass-based binder used is between 0.5% and 5% by weight, preferably between 0.75% and 4% by weight, most preferably between 1% and 3.5% by weight, each relative to the mould base material. The data refer to the total amount of water glass binder, including the (especially aqueous) solvent or diluent, the dissolved water glass and the (possible) solids content (together=100% by weight).

Powdery or particulate is understood to mean a solid powder (including dust) or granulate that is pourable and thus sievable.

The moulding material mixture according to the invention contains a portion of a particulate amorphous silicon dioxide in order to increase the strength level of the casting moulds produced with such moulding material mixtures. Increasing the strengths of the casting mould, especially increasing the heat strengths, can be beneficial in the automated manufacturing process. Synthetically produced amorphous silica is particularly preferred.

The particulate amorphous silicon dioxide preferably used according to the present invention has a water content of less than 15% by weight, more preferably less than 5% by weight and most preferably less than 1% by weight.

The particulate amorphous SiO₂ is used as powder (including dusts). Both synthetically produced and naturally occurring silicas can be used as amorphous SiO₂. The latter are known, for example, from DE 102007045649, but are not preferred because they usually contain not insignificant crystalline contents and are therefore classified as carcinogenic. Synthetic is understood to mean non-naturally occurring amorphous SiO₂, i.e. synthetic production involves a deliberate chemical reaction as it is initiated by a human being, e.g. the production of silica sols by ion exchange processes as alkali silicate solutions, precipitation from alkali silicate solutions, flame hydrolysis of silicon tetrachloride, reaction of silica sand with coke in an electric arc furnace in the production of ferrosilicon and silicon. The amorphous SiO₂ produced by the latter two processes is also called pyrogenic SiO₂.

Occasionally, synthetic amorphous silica is understood to mean only precipitated silica (CAS No. 112926-00-8) and flame hydrolytically produced SiO₂ (pyrogenic silica, fumed silica, CAS No. 112945-52-5), while the product resulting from ferrosilicon or silicon production is referred to simply as amorphous silica (silica fume, microsilica, CAS No. 69012-64-12). For the purposes of the present invention, the product resulting from ferrosilicon or silicon production is also understood to mean amorphous SiO₂.

Preferably used are precipitated silicas and pyrogenic, i.e. flame-hydrolytically or arc-produced silica. Particularly preferred are amorphous silica produced by thermal decomposition of ZrSO₄ (described in DE 102012020509 A1) and SiO₂ produced by oxidation of metallic Si by means of an oxygen-containing gas (described in DE 102012020510 A1). Also preferred is fused quartz powder (mainly amorphous silica) produced by melting and rapid re-cooling of crystalline quartz so that the particles are spherical and not splintery (described in DE 1020120511 A1).

The average particle size of the amorphous silica is preferably less than 100 μm, more preferably less than 70 μm. The sieve residue of the particulate amorphous SiO₂ when passing through a sieve with 125 μm mesh size (120 mesh) is preferably not more than 10% by weight, more preferably not more than 5% by weight and most preferably not more than 2% by weight. Irrespective thereof, the sieve residue on a sieve with a mesh size of 63 μm is less than 10% by weight, preferably less than 8% by weight. The sieve residue is determined according to the machine sieving method described in DIN 66165 (Part 2), wherein a chain ring is additionally used as a sieving aid.

The average primary particle size of the particulate amorphous silicon dioxide may be between 0.05 μm and 10 μm, more preferably between 0.1 μm and 5 μm and most preferably between 0.1 μm and 2 μm. The primary particle size can be determined, e.g., by dynamic light scattering (e.g. Horiba LA 959) as well as checked by scanning electron microscope images (SEM images with, e.g., Nova NanoSEM 230 from FEI). Furthermore the SEM images helped to make details of the primary particle shape visible down to the order of magnitude of 0.01 μm. The silica samples were dispersed in distilled water for the SEM measurements and then placed on an aluminium holder covered with copper tape before the water was evaporated.

Furthermore, the specific surface area of the particulate amorphous silicon dioxide was determined using gas adsorption measurements (BET theory) according to DIN 66131. The specific surface area of the particulate amorphous SiO₂ is between 1 and 200 m²/g, preferably between 1 and 50 m²/g, most preferably between 1 and 19 m²/g. If necessary, the products can also be mixed, e.g. to obtain specific mixtures with certain particle size distributions.

Depending on the type of production and the producer, there may be considerable variations in the purity of the amorphous SiO₂. Types with a content of at least 85% by weight, preferably at least 90% by weight and most preferably at least 95% by weight of silica have proven to be suitable.

Depending on the application and the desired strength level, the amount of particulate amorphous SiO₂ used is between 0.1% by weight and 2% by weight, preferably between 0.1% by weight and 1.8% by weight, most preferably between 0.1% by weight and 1.5% by weight, each relative to the mould base material.

The ratio of water glass binder to particulate amorphous silicon dioxide can be varied within wide limits. This is to advantage in that the initial strengths of the moulds and/or cores, i.e. the strength immediately after removal from the mould, can be greatly improved without significantly affecting the final strengths. On the one hand, high initial strengths are desired in order to be able to transport the moulds and/or cores without problems after production or assemble them into whole core packages; on the other hand, the final strengths should not be too high in order to avoid difficulties with core disintegration after casting, i.e. it should be possible to easily remove the mould base material from cavities in the casting mould after casting.

Relative to the total weight of the water glass (including diluent or solvent), the content of the amorphous SiO₂ is preferably from 1 to 80% by weight, more preferably from 2 to 60% by weight, particularly preferably from 3 to 55% by weight and most preferably between 4 to 50% by weight. Alternatively and irrespective thereof, the preferred ratio of solids in the water glass (based on the oxides, i.e. the total mass of alkali metal oxide and silica) to amorphous SiO₂ is 10:1 to 1:1.2 (parts by weight).

According to EP 1802409 B1, the amorphous silica can be added directly to the refractory both before and after the addition of the water glass, including any substances dissolved or suspended therein; but it is also possible, as described in EP 1884300 A1 (=US 2008/029240 A1), to first prepare a mixture of the SiO₂ with at least part of the water glass and/or the sodium hydroxide solution and then add this to the refractory. Any remaining water glass not used for the premix may be added to the refractory before or after the premix is added or together with it. Preferably, the amorphous SiO₂ is added to the refractory before the water glass is added.

In a further embodiment, at least aluminium oxides and/or aluminium/silicon mixed oxides in particulate form or metal oxides of aluminium and zirconium in particulate form can be added in concentrations between 0.05% by weight and 4% by weight, preferably between 0.1% by weight and 2% by weight, more preferably between 0.1% by weight and 1.5% by weight and most preferably between 0.1% by weight and 2.0% by weight or between 0.3% by weight and 0.99% by weight, each relative to the total moulding material mixture.

The solids mixture according to the invention contains one or more oxidic boron compounds, in particular in particulate powder form. The average particle size of the oxidic boron compound is preferably less than 1 mm, more preferably less than 0.5 mm, most preferably less than 0.25 mm. The particle size of the oxidic boron compound is preferably greater than 0.1 μm, more preferably greater than 1 μm and most preferably greater than 5 μm.

The residue on a sieve with a mesh size of 1.00 mm is less than 5% by weight, preferably less than 2.0% by weight and most preferably less than 1.0% by weight. Irrespective of the preceding information and with particular preference, the sieve residue on a sieve with a mesh size of 0.5 mm is preferably less than 20% by weight, particularly preferably less than 15% by weight, more preferably less than 10% by weight and most preferably less than 5% by weight. Irrespective of the preceding information and with particular preference, the sieve residue on the sieve with a mesh size of 0.25 mm is preferably less than 50% by weight, more preferably less than 25% by weight and most preferably less than 15% by weight. The sieve residue is determined according to the machine sieving method described in DIN 66165 (Part 2), wherein a chain ring is additionally used as a sieving aid.

Oxidic boron compounds are compounds in which the boron is present in the +3 oxidation state. Furthermore, the boron is coordinated with oxygen atoms (in the first coordination sphere, i.e. as nearest neighbours)—either with 3 or 4 of oxygen atoms.

Preferably, the oxidic boron compound is selected from the group consisting of borates, boric acids, boric anhydrides, borosilicates, borophosphates, borophosphosilicates and mixtures thereof, wherein the oxidic boron compound preferably contains no organic groups.

Boric acids are orthoboric acid (chemical formula H₃BO₃) and meta- or polyboric acids (chemical formula (HBO₂)ₙ). Orthoboric acid occurs, for example, in water vapour sources and as the mineral sassolite.

Orthoboric acid can also be produced from borates (e.g. borax) by acid hydrolysis. Meta- or polyboric acids, for example, can be produced from orthoboric acid by intermolecular condensation through heating. Boric anhydride (chemical formula B₂O₃) can be produced by annealing boric acids. Boric anhydride is obtained as a mostly glassy, hygroscopic mass, which can then be crushed.

In principle, borates are derived from boric acids. They can be of both natural and synthetic origin. Borates are made up of borate structural units in which the boron atom is surrounded by either 3 or 4 oxygen atoms as the nearest neighbours. The individual structural units are mostly anionic and can either be present in isolation within a substance, e.g. in the case of the orthoborate [BO₃]³⁻, or linked to each other, such as metaborates [BO₂]ⁿ⁻ whose units can be linked to form rings or chains; if one considers such a linked structure with corresponding B—O—B bonds, such a structure is anionic in the overall view.

Preference is given to borates that contain linked B—O—B units. Orthoborates are suitable but not preferred. For example, alkali and/or alkaline earth cations, but also for example zinc cations, preferably sodium or calcium cations, more preferably calcium, serve as counterions to the anionic borate units.

In the case of monovalent or divalent cations, the molar mass ratio between cation and boron can be described in the following way: MₓO:B₂O₃, where M is the cation and x is 1 for divalent cations and 2 for monovalent cations. The molar mass ratio of MₓO (x=2 for M=alkali metals and x=1 for M=alkaline earth metals) to B₂O₃ can vary in the range of wide limits, but preferably it is smaller than 10:1, preferably less than 5:1 and most preferably less than 2:1. The lower limit is preferably greater than 1:20, more preferably greater than 1:10 and most preferably greater than 1:5.

Suitable borates are also those in which trivalent cations serve as counterions to the anionic borate units, such as aluminium cations in the case of aluminium borates.

Natural borates are mostly hydrated, i.e. water is contained as structural water (as OH groups) and/or as crystal water (H₂O molecules). Borax or also borax decahydrate (disodium tetraborate decahydrate), whose chemical formula is given in the literature either as [Na(H₂O)₄]₂[B₄O₅(OH)₄] or, to simplify matters, as Na₂B₄O₇*10H₂O, is considered to be an example. Both hydrated and non-hydrated borates can be used, but the hydrated borates are preferred.

Both amorphous and crystalline borates can be used. Amorphous borates are understood to be, for example, alkali or alkaline earth borate glasses.

Borosilicates, borophosphates and borophosphosilicates are understood to mean compounds that are mostly amorphous/glassy.

In the structure of these compounds there are not only neutral and/or anionic boron-oxygen coordinations (e.g. neutral BO₃ units and anionic BO₄⁻ units), but also neutral and/or anionic silicon-oxygen and/or phosphorus-oxygen coordinations, wherein the silicon is in the +4 oxidation state and the phosphorus is in the +5 oxidation state. The coordinations can be connected to each other via bridging oxygen atoms, such as in the case of Si—O—B or P—O—B. Metal oxides, in particular alkali metal and alkaline earth metal oxides, can be incorporated into the structure of the borosilicates, borophosphates and borophosphosilicates, which serve as so-called network modifiers. Preferably, the content of boron (calculated as B₂O₃) in the borosilicates, borophosphates as well as borophosphosilicates is greater than 15% by weight, preferably greater than 30% by weight, more preferably greater than 40% by weight, relative to the total mass of the corresponding borosilicate, borophosphate or borophosphosilicate.

From the group of borates, boric acids, boric anhydrides, borosilicates, borophosphates and/or borophosphosilicates, however, the borates, borophosphates and borophosphosilicates, and in particular the alkali metal and alkaline earth metal borates, are clearly preferred. One reason for this selection is the strong hygroscopicity of boric anhydride, which affects its possible use as a powder additive during prolonged storage of the same. In casting trials with an aluminium melt, it has also been shown that borates lead to significantly better casting surfaces than boric acids, so that the latter are less preferred.

Borates are particularly preferred. Particularly preferred are alkali and/or alkaline earth borates, of which sodium borates and/or calcium borates are preferred. Calcium borate is particularly preferred.

The content of the oxidic boron compound, in each case relative to the refractory mould base material, is preferentially less than 1.0% by weight, preferably less than 0.4% by weight, more preferably less than 0.2% by weight and most preferably less than 0.1% by weight. The lower limit is preferentially greater than 0.002% by weight, preferably greater than 0.005% by weight, more preferably greater than 0.01% by weight and most preferably greater than 0.02% by weight.

Furthermore, the moulding material mixture used according to the invention contains a phosphate-containing compound which includes inorganic phosphate compounds in which the phosphorus is in the +5 oxidation state and is surrounded by oxygen atoms in the immediate vicinity.

The phosphate can be present as an alkali metal or alkaline earth metal phosphate, wherein alkali metal phosphates and in particular the sodium salts are preferred.

Orthophosphates as well as polyphosphates, pyrophosphates or metaphosphates can be used as phosphates, wherein polyphosphates and metaphosphates are preferred and sodium polyphosphates and sodium metaphosphates are particularly preferred. The phosphates can be produced, for example, by neutralising the corresponding acids with a corresponding base, for example alkali metal base, such as NaOH, or possibly also an alkaline earth metal base, wherein not all negative charges of the phosphate must necessarily be replaced with metal ions. The phosphates can be introduced into the moulding material mixture in both crystalline and amorphous form.

Polyphosphates are understood to mean, in particular, linear phosphates that comprise more than one phosphorus atom, wherein the phosphorus atoms are each connected to each another via oxygen bridges.

Polyphosphates are obtained by condensation of orthophosphate ions with elimination of water to give a linear chain of PO₄ tetrahedra, which are each connected at their corners.

Polyphosphates have the general formula (O(PO₃)ₙ)⁽ⁿ⁺²⁾⁻, wherein n>=2 corresponds to the chain length. A polyphosphate can comprise up to several hundred PO₄ tetrahedra. However, polyphosphates with shorter chain lengths are preferred. Preferably, n has values of 3 to 100, most preferably 5 to 50. Higher condensed polyphosphates can also be used, i.e. polyphosphates in which the PO₄ tetrahedra are connected to each other via more than two corners and therefore show polymerisation in two or three dimensions.

Metaphosphate is understood to mean cyclic structures built up from PO₄ tetrahedra, which are each connected to each other at their corners. Metaphosphates have the general formula (PO₃)ₙ)ⁿ⁻, wherein n is at least 3. Preferably, n has values from 3 to 10.

Both individual phosphates and mixtures of different phosphates can be used as phosphate-containing compounds.

Independently, the phosphate-containing compound preferably contains between 40% and 90% by weight, more preferably between 50% and 80% by weight of phosphorus, i.e. calculated to be P₂O₅. The phosphate-containing compound may itself be added to the moulding material mixture in solid or dissolved form. Preferably, the phosphate-containing compound is added to the moulding material mixture as a solid.

Surprisingly, the combination of very small additions of one or more powdered oxidic boron compounds and one or more phosphate-containing compounds has shown to significantly improve the stability of the casting mould to water coatings in the coating-drying process.

The weight ratio of the oxidic boron compound to the phosphate-containing compound can vary over wide ranges and is preferably 1:30 to 1:1, preferably 1:25 to 1:2, most preferably 1:20 to 1:3.

If compounds containing both boron oxide and phosphate groups are used, the stoichiometric ratio of P:B is considered. If the stoichiometric ratio of P:B is ≤1, the compound is counted as a phosphate-containing compound, while all other compounds are counted as an oxidic boron compound.

It has also been surprisingly shown that the moisture resistance of the coated moulds and/or cores is improved by the addition of combinations of oxidic boron compounds and phosphate-containing compounds to the moulding material mixture according to the invention, thus increasing their strength or storage stability.

According to an advantageous embodiment, the moulding material mixture according to the invention contains a portion of platelet-shaped lubricants, in particular graphite or MoS₂. The amount of the added platelet-shaped lubricant, in particular graphite, is preferably 0.05% to 1% by weight, most preferably 0.05% to 0.5% by weight, relative to the mould base material.

According to a further advantageous embodiment, surface-active substances, in particular surfactants, which improve the flowability of the moulding material mixture and the strength in a water-containing atmosphere, can also be used. Suitable representatives of these compounds are described, for example, in WO 2009/056320 A1 (=US 2010/0326620 A1). Preferably, anionic surfactants are used for the moulding material mixture according to the invention. Particularly mentioned here are surfactants with sulphuric acid or sulphonic acid groups or their salts. In the moulding material mixture according to the invention, the pure surface-active substance, in particular the surfactant, is preferably present in an amount of 0.001% by weight to 1% by weight, more preferably 0.01% by weight to 0.2% by weight, relative to the weight of the refractory mould base material.

The moulding material mixture according to the invention is an intensive mixture of at least the components mentioned. Therein, the particles of the refractory mould base material are preferably coated with a layer of the binder. By evaporating the water present in the binder (e.g. approx. 40 to 70% by weight, relative to the weight of the binder), a firm cohesion can then be achieved between the particles of the refractory mould base material.

Despite the high strengths achievable with the binder system according to the invention, the casting moulds produced with the moulding material mixture according to the invention surprisingly show very good disintegration after casting, even in iron and steel casting, so that the casting mould can be easily removed from narrow and angled sections of the casting after the casting process.

The casting moulds are generally suitable for casting metals, such as light metals, nonferrous metals or ferrous metals. However, the moulding material mixture according to the invention is particularly preferably suitable for casting iron and iron alloys.

The invention further relates to a method for the production of coated casting moulds for metal processing, wherein the above-described moulding material mixture is used. The method according to the invention comprises the steps of:
providing the above-mentioned moulding material mixtures by combining and mixing at least the above-mentioned obligatory components;
moulding the moulding compound;
hardening the moulded moulding material mixture to obtain the hardened mould;
applying a water-based coating to the hardened mould and subsequent drying.

In the production of the moulding material mixture used according to the invention, the procedure is generally such that the refractory moulding base material is first introduced and then the binder and the additive are added while stirring. The additives described above can be added to the moulding material mixture in any form. They can be added individually or as a mixture. According to a preferred embodiment, the binder is provided as a two-component system, wherein a first liquid component comprises the water glass and, where appropriate, a surfactant (see above), and a second but solid component comprising the particulate silica and one or more oxidic boron compounds and one or more phosphate-containing compounds, and, where appropriate, any other solid additives mentioned above, excluding the moulding base materials.

In the production of the moulding material mixture, the refractory moulding base material is preferably placed in a mixer and then, preferably, the solid component(s) of the binder is/are first added and mixed with the refractory moulding base material. The mixing time is selected such that the refractory moulding base material and the solid binder component are intimately mixed. The mixing time depends on the quantity of the moulding material mixture to be produced and on the mixing unit used. Preferably, the mixing time is selected between 1 and 5 minutes.

While preferably continuing to agitate the mixture, the liquid component of the binder is then added and then the mixture is preferably further mixed until a uniform layer of the binder has formed on the grains of the refractory mould base material.

Here, too, the mixing time depends on the quantity of the moulding material mixture to be produced and on the mixing unit used. Preferably, the duration for the mixing process is selected from 1 to 5 minutes. A liquid component is understood to mean both a mixture of different liquid components and the totality of all individual liquid components, wherein the latter can be added to the moulding material mixture together or one after the other. Likewise, a solid component is understood to mean both the mixture of individual or all of the solid components described above and the totality of all of the individual solid components, wherein the latter can be added to the moulding material mixture together or also one after the other.

According to a further embodiment, the liquid component of the binder can also be added to the refractory mould base material first and only then can the solid component be added to the mixture. According to a further embodiment, 0.05% by weight to 0.3% by weight of water, relative to the weight of the mould base material, is first added to the refractory mould base material and only then are the solid and liquid components of the binder added.

The moulding material mixture is then shaped into the desired form. For example, the moulding material mixture may be shot into the moulding tool by means of a core shooter using compressed air. The moulding material mixture is then hardened using all the methods known for water glass-based binders, e.g. heat hardening, gassing with CO₂ or air or a combination of both, and hardening with liquid or solid catalysts. Heat hardening is preferred.

During heat hardening, water is removed from the moulding material mixture. This probably also initiates condensation reactions between silanol groups, so that cross-linking of the water glass occurs.

Heating can take place, for example, in a moulding tool, which preferably has a temperature of 100° C. to 300° C., more preferably a temperature of 120° C. to 250° C. It is possible to fully harden the casting mould already in the moulding tool. However, it is also possible to harden the casting mould only in its peripheral area so that it has sufficient strength to be removed from the moulding tool. The moulding tool can then be completely hardened by removing further water from it. This can be done in a furnace, for example. The water can also be removed, for example, by evaporating the water at reduced pressure.

The hardening of the casting mould can be accelerated by blowing heated air into the moulding tool. In this embodiment of the method, a rapid removal of the water contained in the binder is achieved, wherein the casting mould is solidified in time periods suitable for industrial application. The temperature of the injected air is preferably 100° C. to 180° C., more preferably 120° C. to 150° C. The flow rate of the heated air is preferably adjusted such that hardening of the casting mould takes place in time periods suitable for industrial application. The time periods depend on the size of the casting moulds produced. The aim is to harden in less than 5 minutes, preferably less than 2 minutes. However, longer periods may be required for very large casting moulds.

The removal of water from the moulding material mixture can also be carried out such that the heating of the moulding material mixture is caused or supported by the irradiation of microwaves. It would be conceivable, for example, to mix the mould base material with the solid, powdery component(s), to apply this mixture in layers to a surface and to print the individual layers with the aid of a liquid binder component, in particular with the aid of a water glass, wherein each layerwise application of the solid mixture is followed by a printing process with the aid of the liquid binder.

At the end of this process, i.e. after the last printing operation has been completed, the entire mixture can be heated in a microwave oven.

The at least partially hardened cores and moulds thus produced are then provided, at least on partial surfaces, with the coating composition according to the invention in the form of a finishing coat or a lining.

The coating composition can be brought into contact with the core or mould by spraying, brushing, dipping or flooding. In use, the coating composition is a liquid with solids suspended therein. To remove the carrier liquid in the coating, i.e. water or where appropriate also low-boiling alcohols, it is dried in air or at an elevated temperature of 60° C. to 220° C., in particular 100° C. to 200° C., preferably 120° C. to 180° C., e.g. in a continuous or batch furnace, e.g. by means of an IR radiator or microwave. The carrier liquid is the component that is vaporisable at 160° C. and normal pressure (1013 mbar) and in this sense, by definition, all that is not solid content.

The carrier liquid can be partially or completely formed by water. The carrier liquid contains more than 50% by weight, preferably 75% by weight, more preferably more than 80% by weight, possibly more than 95% by weight of water. The other components in the carrier liquid may be organic solvents. Suitable solvents are alcohols, including polyalcohols and polyether alcohols. Exemplary alcohols are ethanol, n-propanol, isopropanol, n-butanol, glycols, glycol monoethers and glycol monoesters.

The solids content of the ready-to-use coating composition is preferably adjusted in the range of 10 to 60% by weight, or—in the sales form (before dilution, in particular with water)—more preferably 30 to 80% by weight.

The coating composition comprises at least 20% by weight, preferably greater than 40% by weight of carrier liquid.

Thus, the coating composition comprises at least one powdery refractory base material prior to addition to the coating composition. The refractory base material is used to seal the pores in a casting mould against the penetration of the liquid metal. Furthermore, the refractory base material provides thermal insulation between the casting mould and the liquid metal. Suitable refractory base materials are particularly those with a melting point at least 200° C. above the temperature of the liquid metal to be cast (at least greater than 900° C.) and which, irrespective thereof, do not react with the metal.

As refractory base materials (for the coating), e.g. pyrophyllite, mica, zirconium silicate, andalusite, fireclay, iron oxide, kyanite, bauxite, olivine, aluminium oxide, quartz, talc, calcined kaolines (metakaolin) and/or graphite can be used alone or as mixtures thereof.

When the clay is used as the suspending agent, the D10 passing fraction may preferably be from 0.01 μm to 5 μm, more preferably from 0.01 μm to 1 μm, most preferably from 0.01 μm to 0.2 μm for the grain size. Preferably, the clay may have a D01 passing fraction from 0.001 μm to 0.2 μm, more preferably from 0.001 μm to 0.1 μm, most preferably from 0.001 μm to 0.05 μm for the particle size.

For mica, the D90 passing fraction preferably is from 100 μm to 300 μm, more preferably from 150 μm to 250 μm, most preferably from 200 μm to 250 μm. Preferably, the D50 passing fraction of the mica may be from 45 μm to 125 μm, more preferably from 63 μm to 125 μm, most preferably from 75 μm to 125 μm. Preferably, the D10 passing fraction may have a grain size from 1 μm to 63 μm, more preferably from 5 μm to 45 μm, most preferably from 10 μm to 45 μm. Preferably, the D01 passing fraction may be from 0.1 μm to 10 μm, more preferably from 0.5 μm to 10 μm, most preferably from 1 μm to 5 μm.

Furthermore, the particle diameter of the refractory base materials of the coating is not particularly limited; any usual grain sizes from 1 μm to 300 μm, more preferably from 1 μm to 280 μm, can be used.

The grain size distribution of the individual solid components of the coating composition can be determined on the basis of the passing fractions D90, D50, D10 and D01. These are a measure of the particle size distribution. Herein, the passing fractions D90, D50, D10 and D01 denote the fractions in 90%, 50%, 10% and 1% of the particles, respectively, which are smaller than the designated diameter. For example, with a D10 value of 5 μm, 10% of the particles have a diameter of less than 5 μm. The grain size and the passing fractions D90, D50, D10 and D01 can be determined by laser diffraction granulometry according to ISO 13320.

The passing fractions are given on a volume basis. For non-spherical particles, a hypothetical spherical grain size is calculated and the corresponding diameter is used as a basis. The grain size is therefore equal to the calculated diameter.

The particle diameters and their distribution are determined by laser diffraction in a water-isopropanol mixture, wherein the suspension is obtained by stirring (only) with a Horiba LA-960 laser scattered light spectrometer from Retsch based on static light scattering (according to DIN/ISO 13320) and by evaluation using the Fraunhofer model.

The grain size is chosen in particular such that a stable structure is created in the coating and such that the coating composition can be easily distributed on the wall of the casting mould, e.g. with a spraying device.

According to one embodiment, the coating composition according to the invention may comprise at least one suspending agent. The suspending agent causes an increase in the viscosity of the coating so that the solid components of the coating composition in the suspension do not sink or sink only to a small extent. Both organic and inorganic materials or mixtures of these materials can be used to increase the viscosity.

Swellable phyllosilicates, which are capable of intercalating water between the layers, can be included as suspending agents. Preferably, the swellable phyllosilicate may be selected from attapulgite (palygorskite), serpentines, kaolines, smectites (such as saponite, montmorillonite, beidellite and nontronite), vermiculite, illite, spiolite, synthetic lithium-magnesium phyllosilicate, laponites RD and mixtures thereof; more preferred are attapulgite (palygorskite), serpentines, smectites (such as saponite, beidellite and nontronite), vermiculite, illite, sepiolite, synthetic lithium-magnesium phyllosilicate, laponites RD and mixtures thereof; and most preferably the swellable phyllosilicate can be attapulgite.

Alternatively or additionally, organic thickening agents can also be selected as suspending agents, as these can be dried to such an extent after application of the protective coating that they hardly release any water on contact with the liquid metal.

Possible organic suspending agents are, for example, swellable polymers such as carboxymethyl, methyl, ethyl, hydroxyethyl and hydroxypropyl cellulose, plant mucilages, polyvinyl alcohols, polyvinyl pyrrolidone, pectin, gelatine, agar agar, polypeptides, and/or alginates.

The content of inorganic suspending agents, relative to the total coating composition, is preferably chosen to be 0.1 to 5% by weight, more preferably 0.5 to 3% by weight, most preferably 1 to 2% by weight.

The content of organic suspending agents, relative to the total coating composition, is preferably chosen to be 0.01 to 1% by weight, more preferably 0.01 to 0.5% by weight, most preferably 0.01 to 0.1% by weight.

The coating composition may include, for example, the combination of certain clays as ingredients of the coatings, which also act as suspending agents. Particularly suitable as clay materials is a combination of

a) 1 to 4 parts by weight, in particular 1 to 2.2 parts by weight of palygorskite;

b) 1 to 4 parts by weight, in particular 1 to 2.2 parts by weight of additives; and

c) 1 to 4 parts by weight, in particular 1 to 2.2 parts by weight, of sodium bentonite (used relative to each other in each case), in particular in a weight ratio of palygorskite to hectorite of 1:0.8 to 1.2 and a ratio of palygorskite to hectorite (together) to sodium bentonite of 1:0.8 to 1.2.

According to another definition, the coating (especially as a concentrate) contains
(A) at least the following clays:
(A1) 1 to 10 parts by weight of palygorskite;
(A2) 1 to 10 parts by weight of hectorite; and
(A3) 1 to 20 parts by weight of sodium bentonite, relative to the ratio of components
(A1), (A2) and (A3) relative to each other; and
(B) a carrier liquid containing water which is completely vaporisable at up to 160° C. and 1013 mbar; and
(C) refractory base materials different from (A).

Therein, the total clay content of the coating composition of the above clays is 0.1 to 4.0% by weight, preferably 0.5 to 3.0% by weight and most preferably 1.0 to 2.0% by weight, relative to the solids content of the coating composition.

According to a preferred embodiment, the coating composition comprises at least one binder as a further component. The binder enables a better fixation of the coating composition or the protective coating made from the coating composition on the surface of the casting mould. In addition, the binder increases the mechanical stability of the coating, so that less erosion is observed under the action of the liquid metal. Preferably, the binder hardens irreversibly so that an abrasion-resistant coating is obtained. Binders that do not soften on contact with humidity are particularly preferred. For example, clays can be used as binders, especially bentonite and/or kaolin. Other suitable binders include starch, dextrin, peptides, polyvinyl alcohol, polyvinyl acetate copolymers, polyacrylic acid, polystyrene, polyvinyl acetate-polyacrylate dispersions and mixtures thereof.

The content of binder is preferably chosen in the range from 0.1 to 20% by weight, more preferably 0.5 to 5% by weight and most preferably 0.2 to 2% by weight, relative to the solids content of the coating composition.

According to a further preferred embodiment, the coating composition contains a portion of graphite. This supports the formation of lamellar carbon at the interface between the casting and the casting mould. The content of graphite is preferably chosen in the range from 0 to 30% by weight, more preferably from 1 to 25% by weight, and most preferably from 1 to 20% by weight, relative to the solids content of the coating composition. Graphite has a favourable effect on the surface quality of the casting when iron is cast.

For example, anionic and non-anionic surfactants, especially those with an HLB value of at least 7, can be used as wetting agents for the coating. An example of such a wetting agent is disodium dioctylsulphosuccinate. The wetting agent is preferably used in an amount of 0.01 to 1% by weight, more preferably 0.05 to 0.3% by weight, relative to the ready-to-use coating composition.

Defoamers, or anti-foaming agents, can be used to prevent foaming during the preparation of the coating composition or during its application.

Foaming during application of the coating composition can lead to an uneven coating thickness and holes in the coating. Silicone or mineral oil, for example, can be used as defoamers. Preferably, the defoamer is present in an amount of 0.01 to 1% by weight, more preferably 0.05 to 0.3% by weight, relative to the ready-to-use coating composition.

Common pigments and dyes may be used in the coating composition, where appropriate. These are added to achieve a different contrast, e.g. between different layers, or to create a stronger separation effect of the coating from the casting. Examples of pigments are red and yellow iron oxide and graphite. Examples of dyes are commercially available dyes such as the Luconyl® dye range from BASF SE. The dyes and pigments are preferably present in an amount of 0.01 to 10% by weight, more preferably 0.1 to 5% by weight, relative to the solids content of the coating composition.

According to a further embodiment, the coating composition contains a biocide to prevent bacterial infestation and thus avoid a negative influence on the rheology of the coating and the binding power of the binders.

This is particularly preferred if the carrier liquid contained in the coating composition is formed essentially from water with regard to weight, i.e. the coating composition according to the invention is provided in the form of a so-called water-based coating.

Examples of suitable biocides are formaldehyde, formaldehyde releasers, 2-methyl-4-isothiazolin-3-one (MIT), 5-chloro-2-methyl-4-iosthiazolin-3-one (CIT), 1,2-benzisothiazolin-3-one (BIT) and biocidal substances containing bromine and nitrile groups. The biocides are usually used in an amount of 10 to 1000 ppm, preferably 50 to 500 ppm, relative to the weight of the ready-to-use coating composition.

The coating composition may be prepared by introducing water and digesting therein a clay acting as a suspending agent using a high shear stirrer.

The refractory base material, pigments (if any) and colourants (if any) are then stirred in until a homogeneous mixture is obtained. Finally, wetting agents (if any), anti-foaming agents (if any), biocides (if any), and binders (if any) are stirred in.

The coating composition may be prepared and distributed as a ready-to-use formulated coating composition. However, the coating composition can also be produced and distributed in concentrated form. In order to provide a ready-to-use coating composition in this case, the amount of (further) carrier liquid necessary to adjust the desired viscosity and density of the coating composition is added.

It is also possible to apply several layers of coating, either in multiple layers each having the same coating to produce a desired layer thickness, or by applying different coatings.

The dry film thickness of the top layer is, for example, 0.01 mm to 1 mm, preferably 0.05 mm to 0.8 mm, more preferably 0.1 mm to 0.6 mm and most preferably 0.2 mm to 0.3 mm.

The dry film thickness of the coating is determined either by measuring bending bars before and after coating (dried) using a micrometre screw (preferred) or by measuring using the wet film thickness comb. For example, the layer thickness can be determined with the comb by scratching off the coating at the end marks of the comb until the substrate is revealed. The thickness of the layer can then be read from the markings on the teeth. Instead, it is also possible to measure the wet film thickness in the matted state according to DIN EN ISO 2808.

The methods according to the invention are suitable as such for the production of all casting moulds customary for metal casting, i.e. for cores and moulds, for example. It is to particular advantage to produce casting moulds that comprise very thin-walled sections.

The casting moulds produced with the moulding material mixture or with the method according to the invention have a high strength immediately after production as well as in the entire production process, in particular the coating-drying process, without the strength of the casting mould after hardening or after coating-drying being so high that removal from the mould is difficult after the casting has been produced and when the casting mould is removed. Furthermore, these casting moulds show a high stability in the uncoated as well as in the coated state at increased humidity, i.e. the casting moulds can surprisingly be stored for a longer period of time without any problems and without loss of quality. As an advantage, the casting mould has a very high stability under mechanical load, so that even thin-walled sections of the casting mould can be realised without being deformed by the metallostatic pressure during casting. In addition, the casting mould is to advantage in that it has significantly improved disintegration properties after metal casting, in particular iron casting, which also enable the coring of thin-walled sections of the casting mould. A further subject of the invention is therefore a casting mould which is obtained by the method according to the invention described above.

In the following, the invention will be explained in more detail by means of examples, without being limited to these. For example, the fact that only heat hardening is described as a hardening method does not constitute a limitation.

### EXAMPLES

The following example is intended to describe and explain the invention without limiting its scope.

### Example: Influence of Powdered Oxidic Boron Compounds and/or Phosphate-Containing Compounds on the Bending Strengths in the Coating-Drying Process

So-called Georg Fischer test bars were produced for testing a moulding material mixture. Georg Fischer test bars are cuboid test bars with the dimensions 180 mm×22.36 mm×22.36 mm. The compositions of the moulding material mixtures are given in Table 1. The following steps were taken to produce the Georg Fischer test bars:
The components listed in Table 1 were mixed in a laboratory paddle mixer HSM10 (HOBART GmbH, Hürth, DE). For this purpose, the silica sand was first introduced and then particulate amorphous SiO₂ and, if necessary, powdery oxidic boron compounds and/or powdered phosphate-containing compounds were added. The mixture was mixed for one minute. The water glass used was sodium water glass, which had contents of potassium. In the following tables, the modulus is therefore given as SiO₂:M₂O, wherein M is the sum of sodium and potassium. In a second step, the water glass was added to the mixture of sand and the aforementioned powdery components, and the mixture was then stirred for another minute.
The moulding material mixtures were transferred into the storage hopper of an L1 Labor Hot-Box core shooter from Lämpe & Mösner GmbH (Schopfheim, DE), whose moulding tool was heated to 180° C.
The moulding material mixtures were introduced into the moulding tool by means of compressed air (3 bar) and remained in the moulding tool for another 35 seconds.
To accelerate the hardening of the compounds, hot air (2 bar, 100° C. when entering the tool) was passed through the moulding tool during the last 25 seconds.
The moulding tool was opened and the test bars removed.

To determine the bending strengths, the test bars (180 mm×22.36 mm×22.36 mm) were measured in a standard bending bar device of the type “Multiserw-Morek LRu-2e”, each with a standard measuring programme “Rg1v_B 870 N/cm²” (3-point bending device) from Multiserw-Morek (Bresnitz, PL). The bending strengths were measured according to the following scheme:
10 seconds after removal (heat strengths);
1 hour after removal (cold strengths);
After storage for 24 hours at room temperature, followed by another 24 hours at 30° C. and 60% relative humidity in a climatic cabinet.

As shown in Table 3, the parameters of the coating composition used were adjusted for the purpose intended here, i.e. application to test cores by means of an immersion application or bath.

The density of the ready-to-use coating composition given in Table 3 was measured according to the standard test method DIN EN ISO 2811-2:2011.

The flow time of the ready-to-use coating composition given in Table 3 was measured according to the standard test method DIN 53211 (1974) using a DIN cup 4.

TABLE 1
Composition of the moulding material mixture.

| | Silica | Alkaline | Amorphous | | | |
|---|---|---|---|---|---|---|
| | sand H 32 | water glass ^{a)} | SiO₂ ^{b)} | Phosphate ^{c)} | Borate ^{d)} | |
| | [PW] | [PW] | [PW] | [PW] | [PW] | |
| 1.1 | 100 | 2.2 | 0.5 | — | — | Not according to |
| | | | | | | the invention |
| 1.2 | 100 | 2.2 | 0.5 | 0.15 | — | Not according to |
| | | | | | | the invention |
| 1.3 | 100 | 2.2 | 0.5 | — | 0.05 | Not according to |
| | | | | | | the invention |
| 1.4 | 100 | 2.2 | 0.5 | 0.15 | 0.05 | According to |
| | | | | | | the invention |

^{a)} Alkali water glass with a SiO₂:M₂O modulus of approx. 2.2
^{b)} Microsilica POS B-W 90 LD (amorphous SiO₂, from Possehl Erzkontor; formed during thermal decomposition of ZrSiO₂)
^{c)} Sodium hexametaphosphate (ICL BK Giulini GmbH) added as a solid
^{d)} Calcium metaborate (Carl Jäger GmbH)
PW = parts by weight

TABLE 2
Strengths of the moulding material mixtures

| | | | | Relative | |
|---|---|---|---|---|---|
| | | | Strength after | retention of | |
| | Heat | Cold | climatic | strength after | |
| | strength | strength | storage | climatic | |
| | [N/cm^{2]} | [N/cm^{2]} | [N/cm²] | storage [%] | |
| 1.1 | 166 | 478 | 215 | 45 | Not according to |
| | | | | | the invention |
| 1.2 | 165 | 490 | 215 | 44 | Not according to |
| | | | | | the invention |
| 1.3 | 156 | 409 | 345 | 84 | Not according to |
| | | | | | the invention |
| 1.4 | 172 | 416 | 344 | 83 | According to the |
| | | | | | invention |

The strength tests of mixtures 1.1 to 1.4 show that the climatic stability of inorganically bound cores is not improved by the addition of a phosphate-containing component alone; the retention of strength in percent after climatic storage is almost identical for mixtures 1.1 (45%) and 1.2 (44%). However, a positive effect is achieved by adding an oxidic boron compound, in this case calcium metaborate. After climatic storage, 84% (mixture 1.3) or 83% (mixture 1.4) of the cold strength is obtained by the addition, while the phosphate-containing component again shows no additional influence in the comparison of mixtures 1.3 and 1.4.

TABLE 3
Parameters of the ready-to-use coating
KERNTOP ® V 302/88. KERNTOP ® V 302/88
is a water-based coating based on aluminium
silicate and graphite, solids approx. 49%
by weight. Viscosity 12 Pa-s (at 25° C.).

| | | | Matt layer |
|---|---|---|---|
| Solids content | Density (BV) | Flow time for | thickness |
| [% by weight] | [Pas] | 4 mm [s] | [μm] |
| 33.8 | 0.6 | 13.0 | 325 |

To determine the softening of foundry cores (i.e. the maximum drop in bending strength), the test cores were coated (sized) one hour after core production with the coating composition according to Table 3 at room temperature (25° C.) by dipping (1 s dipping, 3 s holding time in the coating composition, 1 s removal). The wet film thickness of the coating was set to about 250 μm.

Subsequently, the coated test cores were dried under the conditions specified below (20 min, 140° C.) in a fan oven and the changes in each of their bending strengths examined under the drying conditions.

The coated test cores were each dried for a period of 20 minutes, and their bending strengths (in N/cm², according to the definition given in leaflet R202 of the Verein Deutscher Gießereifachleute (Association of German Foundry Experts), October 1987 edition) were measured at various times during drying, and then again one hour after the end of the drying process, using a standard bending bar device type “Multiserw-Morek LRu-2e”, evaluated in each case according to the standard measuring programme “Rg1v_B 870.0 N/cm²” (3-point bending strength).

Table 4 shows the strength values for the examined coated test cores, produced with the moulding material mixtures 1.1 to and the coating according to Table 3. Therein, the cold strength of the uncoated cores, the minimum strength during the coating-drying process (absolute value), and the relatively largest drop in strength during the coating-drying process are compared. In addition, the cold strengths of the coated test cores are listed.

TABLE 4
Absolute bending strengths before and after the
coating-drying process as well as the minimum
bending strengths (related to the cold strengths,
uncoated) during the coating-drying process
(20 min, 140° C.).

| | | Minimum | Maximum | | |
|---|---|---|---|---|---|
| | | bending | relative | | |
| | Cold | strength | drop in | Cold | |
| | strength, | during the | bending | strengths, | |
| | uncoated | coating-drying | strength | coated | |
| | [N/cm²] | process [N/cm²] | [%] | [N/cm²] | |
| 1.1 | 478 | 56 | 88 | 319 | Not |
| | | | | | according to |
| | | | | | the invention |
| 1.2 | 490 | 115 | 77 | 329 | Not |
| | | | | | according to |
| | | | | | the invention |
| 1.3 | 409 | 154 | 62 | 344 | Not |
| | | | | | according to |
| | | | | | the invention |
| 1.4 | 416 | 256 | 38 | 315 | According |
| | | | | | to the |
| | | | | | invention |

The comparison of the minimum strengths during drying of the coating shows first of all a strong drop in strength for mixture 1.1; here up to 88% is lost compared to the cold strength of the uncoated cores.

For mixtures 1.2 to 1.4, this maximum loss in strength is reduced to 77-38%.

The application of a water-containing coating to an inorganic core suggests a collapse in strengths, as water is introduced into a moisture-sensitive system. The experiments described in this application show that the addition of an oxidic boron compound has a positive effect on maintaining the strength of a coated inorganic core (cf. Table 4, mixture 1.3).

For mixtures 1.2 and 1.4, no effect on the climatic stability by adding a phosphate-containing component is evident from the results in Table 2. In contrast, a positive effect is evident from the results in Table 4 when comparing mixtures 1.1 and 1.2, wherein the phosphate-containing component increases the retention of strength during the coating-drying process.

Likewise, when comparing mixtures 1.2, 1.3 and 1.4, it can be seen from Table 4 that the combined addition of a phosphate-containing component and an oxidic boron compound produces a stronger effect than the single addition of both components, and surprisingly the highest strength retention during the coating-drying process is achieved with the combined addition.

1. A mould or core having a coating obtained by moulding and hardening a moulding material mixture to obtain a mould or core and the mould or core, wherein the moulding material mixture at least comprises:
a refractory mould base material;
water glass;
particulate amorphous silicon dioxide, in the range of 0.1 to 2% by weight, relative to the weight of the refractory mould base material;
at least one oxidic boron compound, in the range of greater than 0.002 and less than 1% by weight, relative to the weight of the refractory mould base material; and
at least one phosphate-containing compound, in the range of 0.05 to 1.0% by weight, relative to the weight of the refractory mould base material; and
the coating is a water-containing coating.

2. The mould or core of claim 1, wherein the coating comprises:
(A) at least the following clays:
(A1) palygorskite, in the range of 1 to 10 parts by weight;
(A2) hectorite, in the range of 1 to 10 parts by weight; and
(A3) sodium bentonite, in the range of 1 to 20 parts by weight, relative to the ratio of components (A1), (A2) and (A3) relative to each other; and
(B) a carrier liquid containing water which is completely vaporisable at up to 160° C. and 1013 mbar; and
(C) a refractory base material, different from (A).

3. The mould or core of claim 2, wherein the coating has one or more of the following features:
(i) a total clay content (A1), (A2) and (A3) of the coating amounting to 0.1% to 4.0% by weight, preferably 0.5 to 3.0% by weight and more preferably 1.0 to 2.0% by weight, relative to the solids content of the coating;
(ii) the carrier liquid comprises more than 50% by weight of water and optionally further contains alcohols, including polyalcohols and polyether alcohols;
(iii) the solids content of the coating composition is from 20% to 90% by weight, more preferably from 30% to 80% by weight;
(iv) the coating composition contains 10 to 85% by weight of refractory base materials relative to the solids content of the coating composition.

4. The mould or core of claim 1, wherein the oxidic boron compound is selected from the group consisting of: borates, borophosphates, borophosphosilicates and mixtures thereof and the oxidic boron compound is in particular a borate, preferably an alkali borate and/or alkaline earth metal borate such as sodium borate and/or calcium borate.

5. The mould or core of claim 1, wherein the oxidic boron compound is built up from B—O—B structural elements and, irrespective thereof, does not contain organic groups.

6. The mould or core of claim 1, wherein the oxidic boron compound is added as a solid in powder form, in particular having an average particle size of greater than 0.1 μm and less than 1 mm, preferably greater than 1 μm and less than 0.5 mm, and more preferably greater than 5 μm and less than 0.25 mm.

7. The mould or core of claim 1, wherein the oxidic boron compound is added or contained in an amount of greater than 0.005% by weight and less than 0.4% by weight, more preferably greater than 0.01% by weight and less than 0.1% by weight, and most preferably greater than 0.02% by weight and less than 0.075% by weight, relative to the weight of the refractory mould base material.

8. The mould or core of claim 1, wherein the refractory mould base material is selected from the group consisting of: comprises silica sand, zircon sand, chrome ore sand, olivine, vermiculite, bauxite, fireclay, glass beads, glass granules, aluminium silicate hollow spheres and mixtures thereof and preferably consists of more than 50% by weight of silica sand relative to the weight of the refractory mould base material.

9. The mould or core of claim 1, wherein greater than 80% by weight, preferably greater than 90% by weight, and more preferably greater than 95% by weight, of the moulding material mixture is refractory mould base material.

10. The mould or core of claim 1, wherein the refractory mould base material has average particle diameters of 100 μm to 600 μm, preferably 120 μm to 550 μm.

11. The mould or core of claim 1, wherein the particulate amorphous silicon dioxide has a surface area determined according to BET of between 1 and 200 m²/g, preferably greater than or equal to 1 m²/g and less than or equal to 30 m²/g, more preferably from 1 to less than or equal to 19 m²/g.

12. The mould or core of claim 1, wherein the moulding material mixture comprises a binder, wherein the binder comprises the water glass, the particulate amorphous silicon dioxide, the oxidic boron compound and the phosphate-containing compound, such that the particulate amorphous silicon dioxide is used in an amount of 1 to 80% by weight, preferably between 2 and 60% by weight, relative to the total weight of the binder.

13. The mould or core of claim 1, wherein the particulate amorphous silicon dioxide has an average primary particle diameter determined by dynamic light scattering of between 0.05 μm and 10 μm, preferably between 0.1 μm and 5 μm, and more preferably between 0.1 μm and 2 μm.

14. The mould or core of claim 1, wherein the particulate amorphous silicon dioxide is selected from the group consisting of: precipitated silicon dioxide, flame-hydrolytically or arc-produced pyrogenic silicon dioxide, amorphous silicon dioxide produced by thermal decomposition of ZrSiO₄, silicon dioxide produced by oxidation of metallic silicon by means of an oxygen-containing gas, spherical particle quartz powder produced by melting and rapid re-cooling of crystalline quartz, and mixtures thereof.

15. The mould or core of claim 1, wherein the moulding material mixture contains the particulate amorphous silicon dioxide in amounts of 0.1 to 1.5% by weight, relative to the mould base material, and, irrespective thereof, the moulding mixture comprises a binder and the particulate amorphous silicon dioxide, wherein the binder comprises the water glass, the particulate amorphous silicon dioxide, the oxidic boron compound and the phosphate-containing compound and the particulate amorphous silicon dioxide is contained in the binder in amounts of 2 to 60% by weight, more preferably 4 to 50% by weight, relative to the weight of the binder including water, wherein the solids content of the binder is from 20 to 55% by weight, preferably from 25 to 50% by weight.

16. The mould or core of claim 1, wherein the particulate amorphous silicon dioxide has a water content of less than 5% by weight and more preferably less than 1% by weight.

17. The mould or core of claim 1, wherein the water glass including the water is present in the moulding material mixture in an amount of 0.75% to 4% by weight, more preferably between 1% and 3.5%, relative to the weight of the refractory mould base material, and wherein, also irrespective thereof, but preferably in combination with the above values, the solids content of water glass further preferentially is from 0.2625 to 1.4% by weight, preferably 0.35 to 1.225% by weight, relative to the weight of the refractory mould base material in the moulding material mixture.

18. The mould or core of claim 1, wherein the water glass has a molar modulus SiO₂/M₂O in the range from 1.6 to 4.0, more preferably 2.0 to less than 3.5, with M=lithium, sodium and potassium or M=sodium and potassium.

19. The mould or core of claim 1, wherein the phosphate-containing compound is an inorganic phosphate compound with phosphorus in the +5 oxidation state, wherein metaphosphates and/or polyphosphates are preferred, in particular each as alkali phosphate or as alkaline earth metal phosphate, wherein more preferably the alkaline earth metal is sodium.

20. The mould or core of claim 1, wherein the moulding material mixture contains the phosphate-containing compound in an amount of 0.1 and 0.5% by weight, relative to the weight of the refractory mould base material.

21. A method of producing a coated mould or core, comprising the steps of:
providing a moulding material mixture as defined in claim 1 by combining and mixing the substances or components recited therein;
introducing the moulding material mixture into a mould; and
obtaining a mould or core by hardening the moulding material mixture in a heat hardening step in which water is heated and removed, preferably by exposing the moulding material mixture to a temperature of 100° C. to 300° C.; and
coating the obtained mould or core with a water-containing coating.

22. The method of claim 21, wherein:
the moulding material mixture is introduced into the mould by means of a core shooter with the aid of compressed air; and
the mould is a moulding tool through which one or more gases flow, wherein the one or more gases includes carbon dioxide, and preferably wherein the carbon dioxide and/or air is heated to above 60° C.

23. The method of claim 21, wherein, for hardening purposes, the moulding material mixture is subjected to a temperature of 100 to 300° C., preferably 120 to 250° C., preferably for less than 5 min, wherein the temperature is further preferably at least partially established by blowing heated air into a moulding tool.

24. A method for metal casting, comprising the step of:
pouring a molten metal, particularly iron, into the mould or core of claim 1.
